(19) United States
(12) Patent Application Publication
(10) Pub. No.: US 2007/0196105 A1
(43) Pub. Date: Aug. 23, 2007

(54) Optical network unit and control method thereof

(75) Inventor: Heng-Yi Yang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/656,499

(22) Filed: Jan. 23, 2007

(30) Foreign Application Priority Data
Feb. 17, 2006 (TW) 095105314

(51) Int. Cl. H04B 10/08

(52) U.S. Cl. 398/38

(57) ABSTRACT

An optical network unit (ONU) includes an optical receiving module, an energy transforming module, an analog-to-digital transforming module and an adjusting module. The optical receiving module receives an optical power signal. The energy transforming module transforms the optical power signal into a level signal. The analog-to-digital transforming module transforms the level signal into a digital signal. The adjusting module generates a power adjusting signal in accordance with the digital signal. A transmission power of the ONU is adjusted in accordance with the power adjusting signal. A control method of the optical network unit includes steps of: receiving an optical power signal; transforming the optical power signal into a level signal; transforming the level signal into a digital signal; generating a power adjusting signal in accordance with the digital signal; and adjusting a transmission power of the ONU in accordance with the power adjusting signal.

### CROSS REFERENCE TO RELATED APPLICATIONS

This Non-provisional application claims priority under 35 U.S.C. §119(a) on Patent Application No. 095105314 filed in Taiwan, Republic of China on Feb. 17, 2006, the entire contents of which are hereby incorporated by reference.

### BACKGROUND OF THE INVENTION

1. Field of Invention

The invention relates to an optical network unit and a control method thereof, and in particular to an optical network unit and a control method thereof capable of actively controlling the transmission power.

2. Related Art

Referring to FIG. 1, a passive optical network (PON) 1 is a technique of transmitting information from one point to multiple other points through a fiber. In general, the passive optical network 1 includes an optical line terminal (OLT) 11, a plurality of optical network units (ONU) 12 and an optical distribution network (ODN) 13. The information is transmitted between the optical line terminal 11 and the optical network units 12 through the optical distribution network 13 consisting of a plurality of optical splitters 131.

A receiving unit of the optical line terminal 11 is necessary to have high sensitivity and wide dynamic range because the operation speed of the receiving unit exceeds 1244.16 Mb/s. The optical network unit 12 has a transmitter for transmitting information to the optical line terminal 11 through the optical distribution network 13. If the transmission power of the transmitter is too high, the load of a receiving unit of the optical line terminal 11 is too heavy. In contrary, if the transmission power is insufficient, the optical line terminal 11 may determine the information as noise and the information may be lost. Therefore, the transmission power between the optical line terminal 11 and the optical network unit 12 needs to be suitable for maintaining the lifetime of the optical line terminal 11 and to avoid the information loss.

The distance between each optical network unit 12 and the optical line terminal 11 is different because the optical network units 12 are located at different places. The conventional transmission power determination method of the optical network unit 12 includes steps of: delivering a test signal to each optical network unit 12 from the optical line terminal 11; delivering an optical power signal to the optical line terminal 11 from each optical network unit 12; measuring an intensity of the optical power signal transmitted from each optical network unit 12 by the optical line terminal 11; and then notifying each optical network unit 12 whether to increase or decrease the transmission power or to maintain the current transmission power. In other words, the transmission power of the optical network unit 12 can only be increased or decreased passively and possess no internal active self-control. Thus, the optical line terminal 11 must be equipped with powerful calculation abilities to maintain the transmission efficiency of the passive optical network 1. As a result, the optical line terminal 11 usually has a complex design.

Therefore, it is an important subject to provide an optical network unit and a control method thereof, which can simplify the complex design of the optical line terminal of the passive optical network, and which functions to actively control or determine the necessary transmission power.

### SUMMARY OF THE INVENTION

In view of the foregoing, the invention is to provide an optical network unit and a control method thereof, which can actively control the transmission power so as to simplify the design of the optical line terminal in a passive optical network and to maintain optimal information transmission.

To achieve the above, an optical network unit includes an optical receiving module, an energy-transforming module, an analog-to-digital transforming module and an adjusting module. The optical receiving module receives an optical power signal. The energy transforming module transforms the optical power signal into a level signal. The analog-to-digital transforming module transforms the level signal into a digital signal. The adjusting module generates a power adjusting signal in accordance with the digital signal. The transmission power of the optical network unit is adjusted in accordance with the power adjusting signal.

Additionally, to achieve the above, a control method of an optical network unit includes steps of: receiving an optical power signal; transforming the optical power signal into a level signal; transforming the level signal into a digital signal; generating a power adjusting signal in accordance with the digital signal; and adjusting a transmission power of the optical network unit in accordance with the power adjusting signal.

As mentioned above, the optical network unit and the control method thereof have the energy transforming module and the adjusting module so that the optical network unit can actively determine and control the level of the required transmission power in accordance with the optical power signal transmitted from the optical line terminal, and simplify a part of the hardware circuit utilizing the analog-to-digital transforming module so as to miniaturize the volume of the optical network unit. Compared to the conventional art, the optical network unit of the invention, applied within a passive optical network, can simplify the design of the optical line terminal. In addition, the optical network unit can dynamically alter the transmission power at any time so as to optimize the efficiency of the information transmission.

### BRIEF DESCRIPTION OF THE DRAWINGS

The invention will become more fully understood from the detailed description given herein below illustration only, and thus is not limitative of the present invention, and wherein:

FIG. 1 is a configuration diagram showing a conventional passive optical network;

FIG. 2 is a block diagram showing an optical network unit according to an embodiment of the invention;

FIG. 3 is a schematic diagram showing an adjusting module of the optical network unit in FIG. 2;

FIG. 4 is a schematic diagram showing the digital signal corresponding to a variable resistor of the adjusting module in FIG. 3; and

FIG. 5 is a flow chart showing a control method of an optical network unit according to the embodiment of the invention.

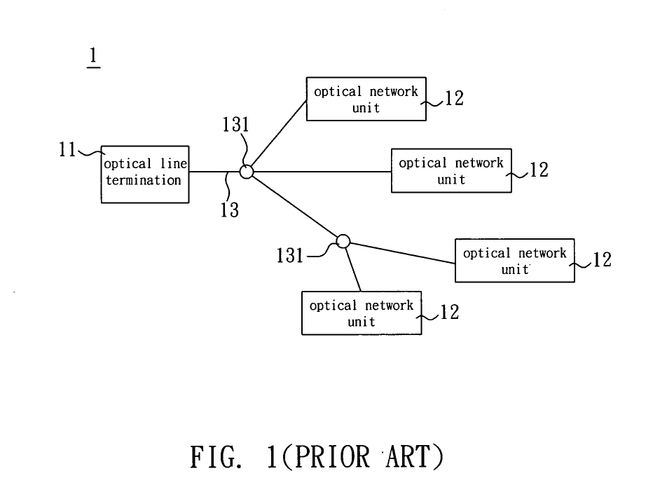

### DETAILED DESCRIPTION OF THE INVENTION

The present invention will be apparent from the following detailed description, which proceeds with reference to the accompanying drawings, wherein the same references relate to the same elements.

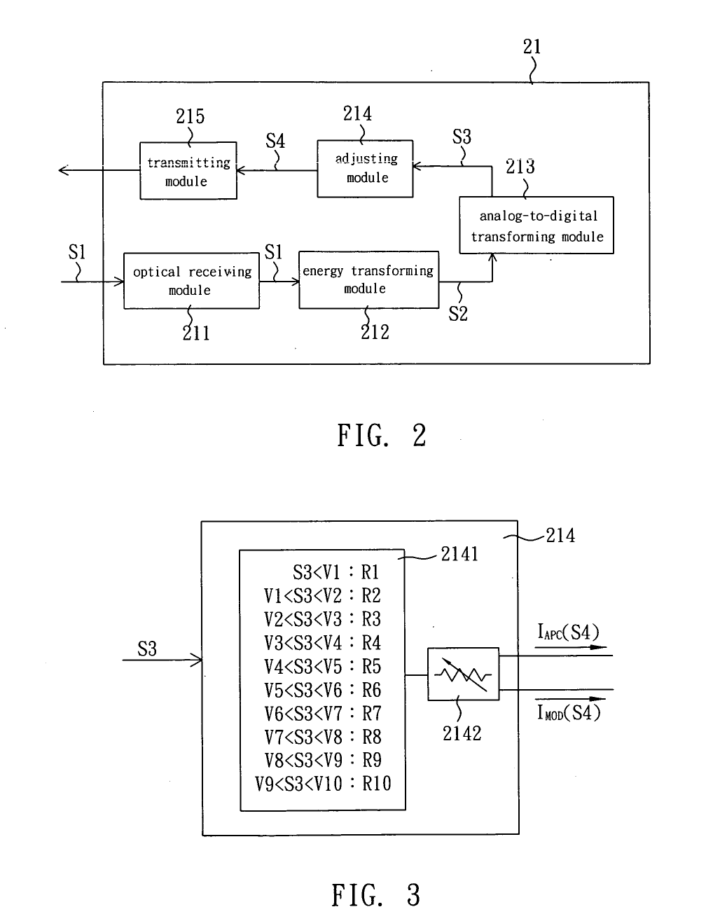

Referring to FIG. 2, an optical network unit 21 according to an embodiment of the invention can be applied in a passive optical network with an optical line terminal (not shown). The optical network unit 21 includes an optical receiving module 211, an energy transforming module 212, an analog-to-digital transforming module 213 and an adjusting module 214.

The optical receiving module 211 receives an optical power signal S1, which is transmitted to the optical receiving module 211 of the optical network unit 21 from the optical line terminal through an optical distribution network (not shown).

The energy transforming module 212 transfers the optical power signal S1 to a corresponding level signal S2, and the analog-to-digital transforming module transforms the level signal S2 into a digital signal S3. In the embodiment, the level signal S2 is a voltage signal.

The adjusting module 213 generates a power adjusting signal S4 in accordance with the digital signal S3, and adjusts the transmission power of a transmitting module 215 of the optical network unit 21 in accordance with the power adjusting signal S4. In the embodiment, the power adjusting signal S4 is a current signal and the transmitting module 215 is a laser module.

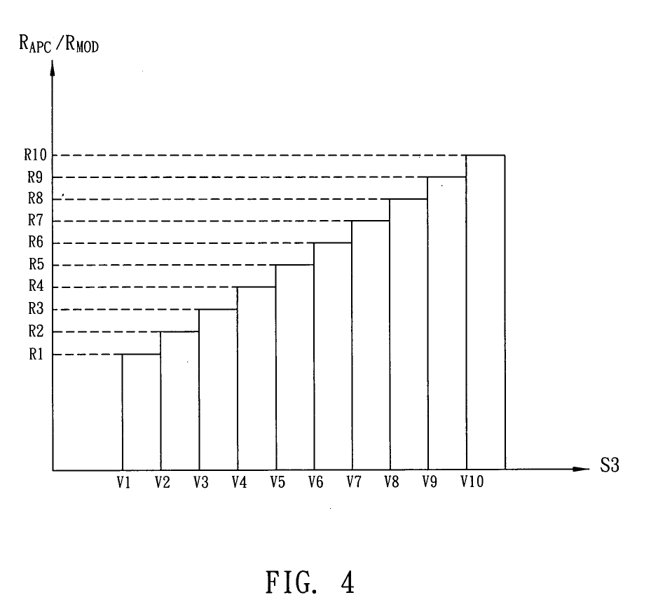

Referring to FIG. 3, the adjusting module 214 includes a lookup table 2141 and at least one variable resistor 2142. The lookup table 2141 determines the value of the variable resistor 2142 in accordance with the digital signal S3 received by the adjusting module 214. In the embodiment, the resistance values of the variable resistor 2142 are divided into ten levels (as shown in FIG. 4), which respectively correspond to the different digital signals S3. Each digital signal S3 has a level corresponding to one resistance value of the variable resistor 2142. The level of the digital signals S3 are arranged between V1 to V10 and are used to determine the corresponding resistance values from R1 through R10 respectively. The determined resistance value is used to control the output current value, and then to determine the level of the power adjusting signal S4. Certainly, the transmission power of the transmitting module 215 is more precise if the lookup table 2141 has more classified levels.

The variable resistor 2142 is a digital variable resistor. In the embodiment, the transmitting module 215 is controlled by a bias current and a modulation current. Therefore the value of the digital variable resistor can be a ratio of a resistance value of a bias resistor R_{APC} to a resistance value of a modulation resistor R_{MOD}. Please note that this is one of the possible applications and thus it should not to be limited in the embodiment. In addition, another digital variable resistor generates a corresponding resistance value in accordance with the digital signal, and the adjusting module 214 generates a bias current I_{APC} and a modulation current I_{MOD} so as to control the transmission power of the transmitting module 215 in accordance with the resistance value of the digital variable resistor.

Also, it is noted that if the adjusting module 214 is made of a digital IC, the digital signal S3 can be classified in accordance with the contents of the lookup table 2141 and then generate the power adjusting signal S4 through the operation of the digital IC. This allows the variable resistor to be omitted, thus reducing the cost.

In the embodiment, if the distance between the optical network unit 21 and the optical line terminal is greater, the resistance value of the variable resistor 2142, which is corresponding to the digital signal S3, generates a greater power adjusting signal S4 so as to increase the transmission power of the transmitting module 215. If the optical network unit 21 is much closer to the optical line terminal, the resistance value of the variable resistor 2142, which is corresponding to the digital signal S3, generates a smaller power adjusting signal S4 so as to transmit the information between the optical network unit 21 and the optical line terminal with the optimal efficiency.

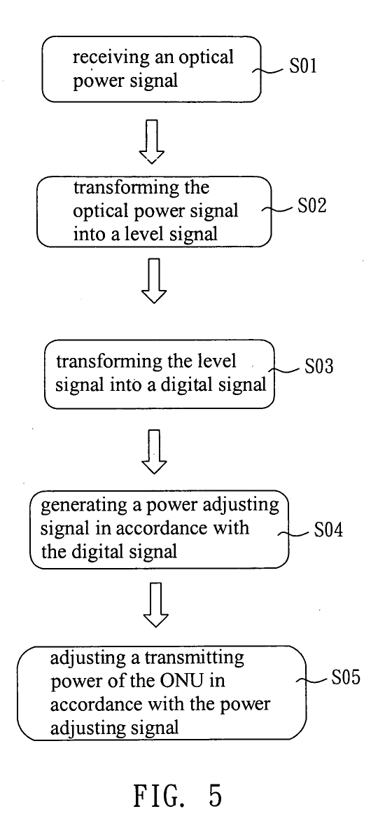

Referring to FIG. 5, a control method of an optical network unit includes the following steps of: receiving an optical power signal (step S01), transforming the optical power signal into a level signal (step S02), transforming the level signal into a digital signal (step S03), generating a power adjusting signal in accordance with the digital signal (step S04), and adjusting the transmission power of the optical network unit in accordance with the power adjusting signal (step S05).

The control method of the optical network unit is illustrated in the above embodiment, so the detailed descriptions are omitted for conciseness.

In summary, the optical network unit and the control method thereof have the energy transforming module and the adjusting module, such that the optical network unit can actively determine and control the level of necessary transmission power in accordance with the optical power signal transmitted from the optical line terminal. Furthermore, the optical network unit and the control method thereof simplify a part of the hardware circuit utilizing the analog-to-digital transforming module so as to miniaturize the volume of the optical network unit. Compared to the conventional art, the optical network unit of the present invention is applied to a passive optical network and can simplify the design of the optical line terminal. In addition, the optical network unit can dynamically alter the transmission power at any time so as to optimize the efficiency of the information transmission.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical network unit, comprising:
an optical receiving module for receiving an optical power signal;
an energy transforming module for transforming the optical power signal to a level signal;
an analog-to-digital transforming module for transforming the level signal to a digital signal; and
an adjusting module generating a power for adjusting signal in accordance with the digital signal so as to adjust a transmission power of the optical network unit.

2. The optical network unit according to claim 1, wherein the level signal is a voltage signal and the power adjusting signal is a current signal.

3. The optical network unit according to claim 1, wherein the adjusting module comprises at least one variable resistor, and the digital signal adjusts a value of the variable resistor so that the adjusting module generates the power adjusting signal in accordance with the value of the variable resistor.

4. The optical network unit according to claim 3, wherein the variable resistor is a digital variable resistor.

5. The optical network unit according to claim 4, wherein the value of the digital variable resistor is a ratio of a resistance value of a bias resistor to a resistance value of a modulating resistor.

6. The optical network unit according to claim 3, wherein the modulating module further comprises a lookup table corresponding to the value of the variable resistor in accordance with the digital signal.

7. The optical network unit according to claim 1, wherein the power adjusting module adjusts the transmission power of a transmitting module of the optical network unit in accordance with the power adjusting signal.

8. The optical network unit according to claim 7, wherein the transmitting module is a laser module.

9. The optical network unit according to claim 1, wherein the optical network unit is applied to a passive optical network.

10. The optical network unit according to claim 1, wherein the adjusting module is a digital IC.

11. A control method of an optical network unit, comprising steps of:
receiving an optical power signal;
transforming the optical power signal into a level signal;
transforming the level signal into a digital signal;
generating a power adjusting signal in accordance with the digital signal; and
adjusting a transmission power of the optical network unit in accordance with the power adjusting signal.

12. The control method according to claim 11, wherein the level signal increases while the power adjusting signal decreases.

13. The control method according to claim 12, further comprising a step of adjusting a value of at least one digital variable resistor in accordance with the digital signal so as to generate the power adjusting signal.

14. The control method according to claim 13, wherein the value of the digital variable resistor is a ratio of a bias resistance value to a modulating resistance value.

15. The control method according to claim 12, wherein the digital signal corresponds to the power adjusting signal and is generated in accordance with a lookup table.

16. The control method according to claim 15, further comprising a step of classifying the digital signal in accordance with the lookup table so as to generate the power adjusting signal by a digital IC.

17. The control method according to claim 11, wherein the level signal is a voltage signal and the power adjusting signal is a current signal.

18. The control method according to claim 11, wherein the power adjusting signal is for adjusting the transmission power of a transmitting module of the optical network unit.

19. The control method according to claim 18, wherein the transmitting module is a laser module.

20. The control method according to claim 11, wherein the optical network unit is applied to a passive optical network.
